(19) United States
(12) Patent Application Publication
(10) Pub. No.: US 2026/0245933 A1
(43) Pub. Date: Aug. 20, 2026

(54) FUEL CELL SYSTEM

(71) Applicant: HONDA MOTOR CO., LTD., TOKYO (JP)

(72) Inventor: Daigo ZENIBAYASHI, WAKO-SHI (JP)

(21) Appl. No.: 19/539,432

(22) Filed: Feb. 13, 2026

(30) Foreign Application Priority Data
Feb. 18, 2025 (JP) 2025-024170

(51) Int. Cl. H01M 8/04746; H01M 8/0258; H01M 8/04014; H01M 8/04082; H01M 8/04119

(52) U.S. Cl. CPC H01M 8/04753; H01M 8/0258; H01M 8/04014; H01M 8/04156; H01M 8/04164; H01M 8/04201

(57) ABSTRACT

A fuel cell system including a connecting section connecting a bypass pipe to an exhaust pipe, wherein the connecting section includes a main body portion having a main flow path extending in a first direction along which the exhaust pipe extends, a joint portion extending outward in a radial direction of the main flow path from a side portion of the main body portion and connected to the bypass pipe, a joint flow path formed inside the joint portion and extending in a second direction orthogonal to the main flow path, and a plurality of flow regulating ribs protruding inward from an inner peripheral surface of the joint portion forming the joint flow path and elongated in the second direction.

### CROSS-REFERENCE TO RELATED APPLICATIONS

This application is based upon and claims the benefit of priority from Japanese Patent Application No. 2025-024170 filed on Feb. 18, 2025, the contents of which are incorporated herein by reference.

### BACKGROUND OF THE INVENTION

### Field of the Invention

The present disclosure relates to a fuel cell system.

### Description of the Related Art

In recent years, research and development have been conducted on fuel cells that contribute to energy efficiency in order to ensure that more people have access to affordable, reliable, sustainable, and modern energy (for example, JP 5140993 B2).

### SUMMARY OF THE INVENTION

In the art related to fuel cells, reliable operation in a low-temperature environment is required. For example, in the case where water adhered to a valve incorporated into a fuel cell system has frozen, the valve is kept closed, causing a problem in operation of a fuel cell system. Therefore, a countermeasure such as disposing various valves at positions higher than the adjacent pipes has been taken (JP 5140993 B2). However, in the case of a bypass pipe for allowing the oxygen-containing gas to bypass the fuel cells, water droplets in the exhaust pipe for the oxygen-containing gas is likely to flow back to the bypass pipe, and it is difficult to prevent water from reaching a bypass valve only by the height difference. Therefore, there is a problem in which a bypass valve disposed in the bypass pipe may become stuck due to freezing.

The present application has been made to solve the above-described problems, and an object thereof is to achieve prevention of backflow of water droplets to the bypass pipe. The present invention thus contributes to energy efficiency.

An aspect of the present disclosure is characterized by a fuel cell system comprising: a supply pipe through which an oxygen-containing gas flows to a fuel cell; an exhaust pipe through which the oxygen-containing gas from the fuel cell is discharged; a bypass pipe connected to the supply pipe and the exhaust pipe and allowing the oxygen-containing gas to bypass the fuel cell; a connecting section connecting the bypass pipe to the exhaust pipe, wherein the connecting section includes a main body portion having a main flow path extending in a first direction along which the exhaust pipe extends, a joint portion extending outward in a radial direction of the main flow path from a side portion of the main body portion, the bypass pipe being connected to the joint portion, a joint flow path formed inside the joint portion and extending in a second direction orthogonal to the main flow path, and a plurality of flow regulating ribs protruding inward from an inner peripheral surface of the joint portion forming the joint flow path and elongated in the second direction.

The fuel cell system of the present disclosure can prevent backflow of water droplets to the bypass pipe, and can prevent water from freezing in and around the bypass valve disposed in the bypass pipe.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an explanatory diagram of an oxygen-containing gas supply system of a fuel cell system according to an embodiment;

FIG. 2 is an explanatory diagram of a layout of pipes around a humidifier shown in FIG. 1;

FIG. 3 is a perspective view of connecting part shown in FIG. 2;

FIG. 4 is a cross-sectional view taken along line IV-IV of FIG. 3; and

FIG. 5 is a cross-sectional view taken along line V-V of FIG. 3;

FIG. 6 is a cross-sectional view taken along line VI-VI of FIG. 3 and illustrating arrangement positions of flow regulating ribs in a joint flow path; and

FIG. 7 is a diagram illustrating a backflow range of water droplets into a bypass flow path, obtained by fluid simulation using the connection parts of the first to third design examples.

### DETAILED DESCRIPTION OF THE INVENTION

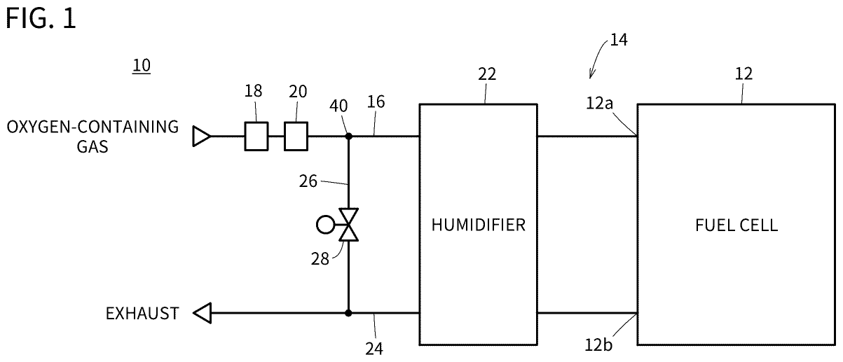

As shown in FIG. 1, a fuel cell system 10 according to the present embodiment includes a fuel cell 12 and an oxygen-containing gas supply system 14. The fuel cell 12 is, for example, a polymer electrolyte fuel cell (PEFC), in which hydrogen is supplied to an anode as a fuel gas and air is supplied to a cathode as an oxygen-containing gas. The oxygen-containing gas supplied to the fuel cell 12 by the oxygen-containing gas supply system 14 has been adjusted to have a predetermined pressure and humidity. The fuel cell system 10 is used as a power source of a moving object such as a passenger car, a truck, a construction machine, an aircraft, or a ship. The fuel cell system 10 may also be used in a stationary power source system.

The oxygen-containing gas supply system 14 includes a supply flow path 16, a compressor 18, a heat exchanger 20, a humidifier 22, an exhaust flow path 24, and a bypass flow path 26. The oxygen-containing gas (air) is supplied to an inlet 12a of the fuel cell 12 through the supply flow path 16. The compressor 18 is connected to the supply flow path 16, and takes in and compresses air.

The heat exchanger 20 is connected to the supply flow path 16 downstream of the compressor 18. The heat exchanger 20 cools the air compressed and heated by the compressor 18.

The humidifier 22 is connected to the supply flow path 16 between the heat exchanger 20 and the inlet 12a of the fuel cell 12. The humidifier 22 is also connected to the exhaust flow path 24. The humidifier 22 humidifies the oxygen-containing gas to be supplied to the fuel cell 12 by transferring water vapor of the oxygen-containing off-gas flowing through the exhaust flow path 24 to the oxygen-containing gas flowing through the supply flow path 16.

The exhaust flow path 24 is connected to an outlet 12b of the fuel cell 12 and the oxygen-containing off-gas (cathode off-gas) from the fuel cell 12 is discharged through the exhaust flow path 24. One end of the bypass flow path 26 is connected to the supply flow path 16 on the upstream side of the humidifier 22, and the other end is connected to the exhaust flow path 24 on the downstream side of the humidifier 22. The bypass flow path 26 allows the oxygen-containing gas in the supply flow path 16 to flow to the exhaust flow path 24 without passing through the humidifier 22 and the fuel cell 12. The bypass flow path 26 releases the oxygen-containing gas excessively supplied due to a difference between the response speed of the compressor 18 and the amount of the oxygen-containing gas required by the fuel cell 12, thereby suppressing variations in the operation condition of the compressor 18.

The bypass flow path 26 is provided with a bypass valve 28. The bypass valve 28 adjusts the flow rate of the oxygen-containing gas flowing through the bypass flow path 26. In the case where the bypass valve 28 is opened, the oxygen-containing gas flows from the supply flow path 16 toward the exhaust flow path 24 due to a pressure difference between the supply flow path 16 and the exhaust flow path 24.

Hereinafter, a structure of piping around the humidifier 22 will be described.

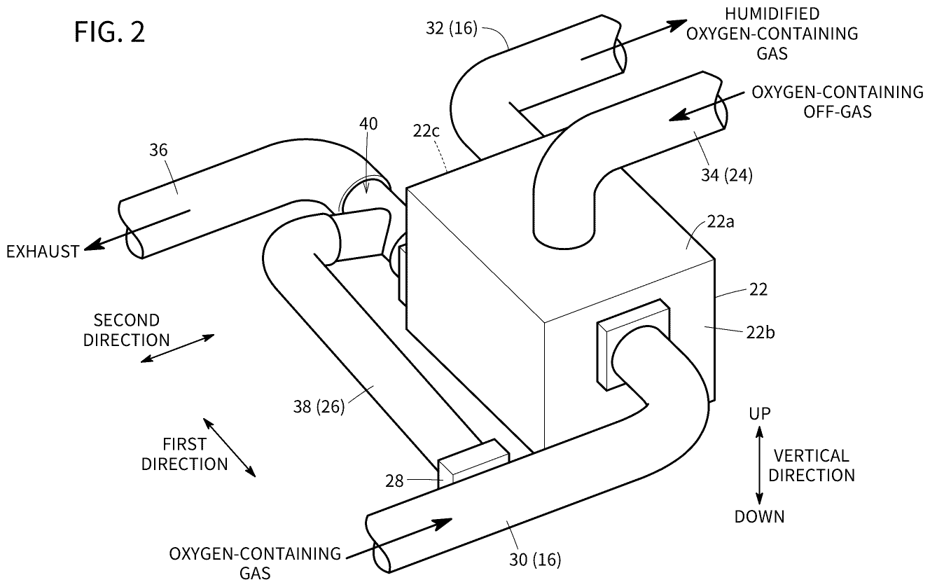

As shown in FIG. 2, the humidifier 22 has a main body 22a including a membrane module. Connected to the first side surface 22b of the main body 22a is a supply pipe 30 forming part of the upstream (heat exchanger 20) side of the supply flow path 16. The oxygen-containing gas flows into the humidifier 22 through the supply pipe 30. Connected to a second side surface 22c of the main body 22a opposite to the first side surface 22b is a first pipe 32 forming the downstream side of the supply flow path 16 extending from the humidifier 22 toward the inlet 12a of the fuel cell 12.

Further, a second pipe 34 is connected to an upper surface of the main body 22a of the humidifier 22. The oxygen-containing off-gas is guided from the outlet 12b of the fuel cell 12 into the humidifier 22 through the second pipe 34 forming the upstream side of the exhaust flow path 24. The oxygen-containing off-gas is discharged from the humidifier 22 through an exhaust pipe 36 connected to the second side surface 22c near the lower end of the main body 22a. The exhaust pipe 36 forms part of the downstream side of the exhaust flow path 24.

The bypass flow path 26 is formed by a bypass pipe 38. The bypass pipe 38 branches from the supply pipe 30 near the humidifier 22, passes along the side of the main body 22a, and extends substantially in the first direction. The bypass pipe 38 is bent toward the exhaust pipe 36 on the downstream side. The downstream side of the bypass pipe 38 is connected to a connecting section 40. The connecting section 40 is a connecting member provided adjacent to the main body 22a and connecting the bypass pipe 38 and the exhaust pipe 36. The bypass valve 28 is disposed near the supply pipe 30 away from the exhaust pipe 36 to prevent adhesion of water droplets.

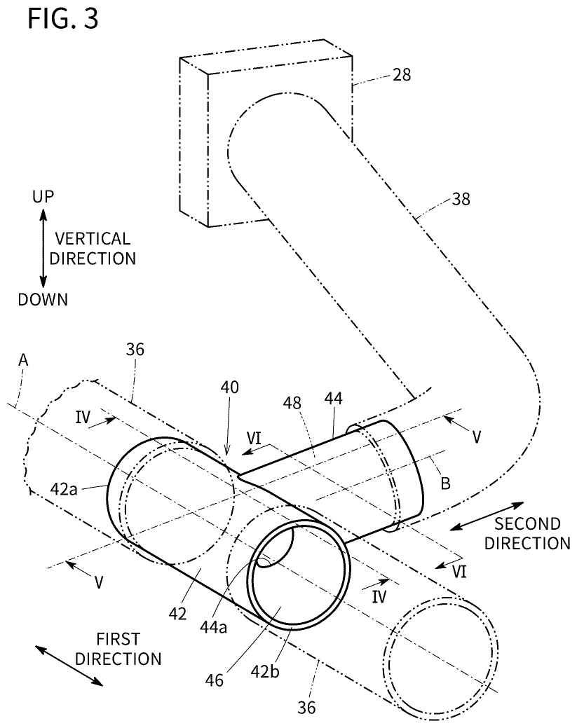

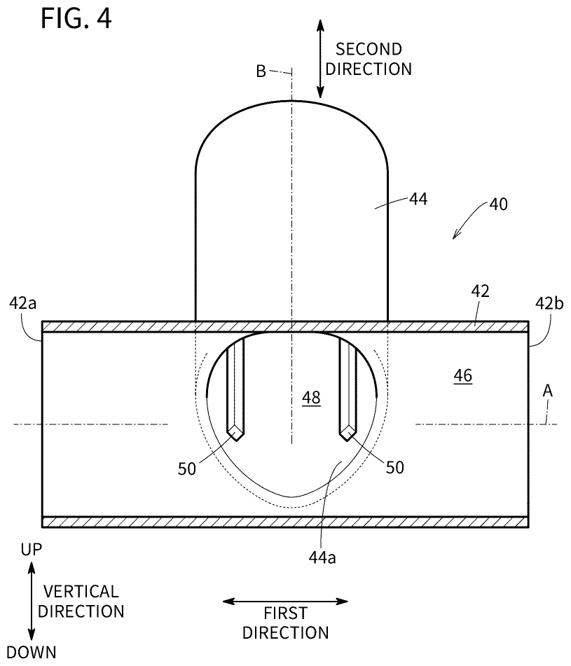

As shown in FIGS. 3 to 6, the connecting section 40 is formed in a T-shape having three flow paths extending in three directions. The connecting section 40 includes a main body portion 42 and a joint portion 44. The main body portion 42 has a cylindrical shape extending in the first direction with a first end 42a connected to the upstream side of the exhaust pipe 36 and a second end 42b connected to the downstream side of the exhaust pipe 36. A main flow path 46 is formed inside the main body portion 42. The main flow path 46 is formed substantially linearly so as to allow the oxygen-containing off-gas (the discharged oxygen-containing gas) to flow smoothly at a high flow rate. The direction of the first centerline A of the main flow path 46 extends along the first direction.

The joint portion 44 extends obliquely upward from a side of the main body portion 42 and outward in the radial direction. The bypass pipe 38 is connected to the joint portion 44. The joint portion 44 is formed in a cylindrical shape, and a joint flow path 48 having a substantially circular cross section is formed inside the joint portion 44. The joint flow path 48 opens to a side of the main flow path 46. The direction of the second centerline B of the joint flow path 48 is referred to as a second direction. The second centerline B of the joint flow path 48 is orthogonal to the first centerline A of the main flow path 46.

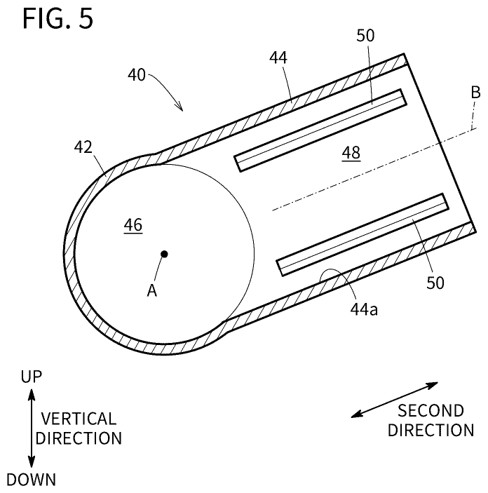

The joint flow path 48 is inclined upward with increasing distance from the first centerline A of the main flow path 46 when viewed from the first direction (see FIG. 5). Such an upward slope reduces the backflow of water droplets into the bypass pipe 38.

A part of the oxygen-containing off-gas flowing through the main flow path 46 flows into the joint portion 44 and the bypass pipe 38 in a swirling manner involving water droplets so that water droplets may flow backward even to the bypass valve 28, which is positioned relatively remotely. Inside the joint flow path 48, a flow swirling around the second centerline B of the joint portion 44 along an inner peripheral surface 44a of the joint portion 44 is generated by the flow in the main flow path 46. Such a swirling flow reaches a portion relatively remote from the connecting section 40 along the extending direction of the joint portion 44 and the extending direction of the bypass pipe 38, and thus is considered to be the main factor that extends the backflow range of the water droplets. Therefore, the backflow of the water droplets to the bypass pipe 38 cannot be sufficiently prevented only by the inclination of the joint flow path 48.

In the present embodiment, a plurality of flow regulating ribs 50 are provided on the inner peripheral surface 44a of the joint portion 44 forming the joint flow path 48. The flow regulating ribs 50 protrude radially inward from the inner peripheral surface 44a to the joint flow path 48 in the radial direction by a short length, and extend long in the second direction. The flow regulating ribs 50 prevent the swirling flow from growing by preventing gaseous flow along the inner peripheral surface 44a of the joint portion 44.

The flow regulating ribs 50 are arranged at equal intervals in the circumferential direction. For example, as shown in the figure, four flow regulating ribs 50 may be provided at intervals of 90°in the circumferential direction of the joint portion 44. However, the number of the flow regulating ribs 50 is not limited to four, and may be two or three, or five or more.

The height of the flow regulating ribs 50 may be, for example, about ½ to ⅛ of the radius of the joint flow path 48. More preferably, the height of the flow regulating ribs 50 is about ¼ of the radius of the joint flow path 48.

If the height of the flow regulating ribs 50 is too small, it is not possible to prevent the spiral flow along the inner peripheral surface 44a from growing inside the joint flow path 48.

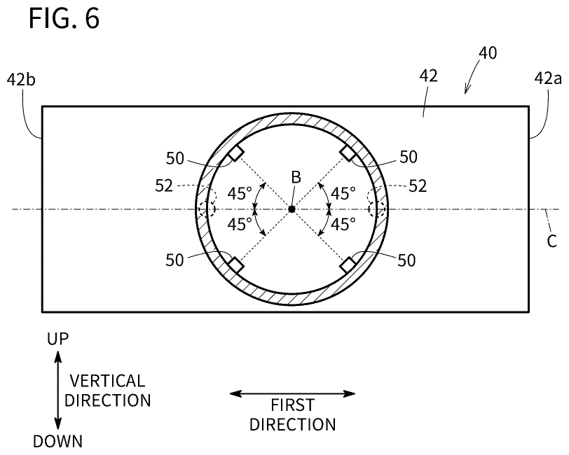

FIG. 6 is a cross-sectional view of the joint portion 44 taken along a plane perpendicular to the second direction. As shown in the drawing, in the case where the arrangement position of the flow regulating ribs 50 is set so as to avoid first direction positions 52 that is the positions where a line C extending in the first direction and passing through the second centerline B of the joint flow path 48 intersects the inner peripheral surface 44a, it is possible to more effectively prevent the backflow of the water droplets to the bypass pipe 38. More preferably, the flow regulating ribs 50 may be disposed at positions shifted in the circumferential direction by ±45° in the circumferential direction with respect to the first direction positions 52.

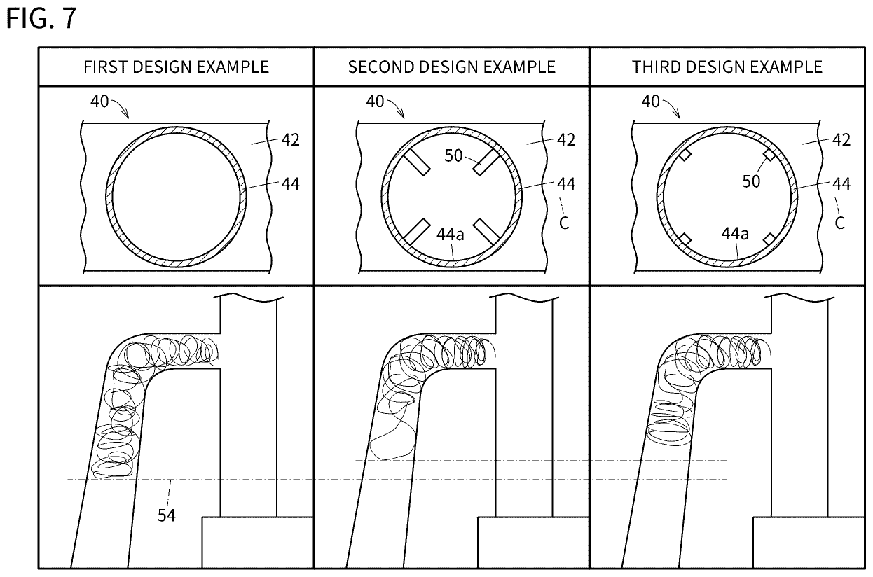

Hereinafter, with reference to FIG. 7, the effect of the height and the circumferential arrangement of the flow regulating ribs 50 on the backflow range of water droplets will be described based on fluid simulation results.

### FIRST DESIGN EXAMPLE

Inside the connecting section 40 of this example, no flow regulating ribs 50 are provided on the inner peripheral surface 44a of the joint portion 44. In the connecting section 40 of the first design example, water droplets flowed back to the first level 54 of the bypass pipe 38.

### SECOND DESIGN EXAMPLE

The connecting section 40 of this example is provided with four flow regulating ribs 50 on the inner peripheral surface 44a of the joint portion 44. The flow regulating ribs 50 of the present design example are disposed at positions separated by ±45° in the circumferential direction with respect to the first direction positions 52. The height of the flow regulating ribs 50 of the present design example is ½ of the radius of the joint portion 44. According to the present design example, growth of the swirling flow is suppressed, and the backflow range of water droplets becomes smaller than the first level 54 which is the backflow range of the first design example.

### THIRD DESIGN EXAMPLE

The connecting section 40 of this example is provided with four flow regulating ribs 50 on the inner peripheral surface 44a of the joint portion 44. The flow regulating ribs 50 of the present design example are disposed at positions separated by ±45° in the circumferential direction with respect to the first direction positions 52. The height of the flow regulating ribs 50 of the present design example is ¼ of the radius of the joint portion 44. According to the present design example, growth of the swirling flow is suppressed more effectively, and the backflow range of water droplets becomes further smaller than that of the second design example.

The following supplementary notes are further disclosed in relation to the above embodiment.

### Supplementary Note 1

The present disclosure is characterized by the fuel cell system (10) comprising: the supply pipe (30) through which the oxygen-containing gas flows to the fuel cell (12); the exhaust pipe (36) through which the oxygen-containing gas from the fuel cell is discharged; the bypass pipe (38) connected to the supply pipe and the exhaust pipe and allowing the oxygen-containing gas to bypass the fuel cell; the connecting section (40) connecting the bypass pipe to the exhaust pipe, wherein the connecting section includes the main body portion (42) having the main flow path (46) extending in the first direction along which the exhaust pipe extends, the joint portion (44) extending outward in a radial direction of the main flow path from the side portion of the main body portion, the bypass pipe being connected to the joint portion, the joint flow path (48) formed inside the joint portion and extending in the second direction orthogonal to the main flow path, and the plurality of flow regulating ribs (50) protruding inward from the inner peripheral surface (44a) of the joint portion forming the joint flow path and elongated in the second direction.

The fuel cell system described above can suppress backflow of water droplets from the exhaust pipe to the bypass pipe and prevent freezing of the bypass valve.

### Supplementary Note 2

In the fuel cell system according to Supplementary Note 1, the plurality of flow regulating ribs may be arranged at equal intervals in a circumferential direction of the joint flow path. This fuel cell system can suppress growth of swirl flow in the circumferential direction inside the joint flow path, and can prevent backflow of water droplets to the bypass pipe.

### Supplementary Note 3

In the fuel cell system according to Supplementary Note 2, the plurality of flow regulating ribs may be arranged at positions shifted from the first direction. This fuel cell system can suppress growth of swirl flow in the circumferential direction inside the joint flow path, and can prevent backflow of water droplets to the bypass pipe.

### Supplementary Note 4

In the fuel cell system according to Supplementary Note 3, the plurality of flow regulating ribs may be provided at positions separated by ±45° with respect to the first direction. The fuel cell system can more effectively prevent backflow of water droplets to the bypass pipe.

### Supplementary Note 5

In the fuel cell system according to any one of Supplementary Notes 1 to 4, the second direction may be inclined upward with increasing distance from the first centerline (A) of the main flow path. The fuel cell system can effectively prevent backflow of water droplets to the bypass pipe.

Although concerning the present disclosure, a detailed description thereof has been presented above, the present disclosure is not necessarily limited to the individual embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, the embodiments can also be implemented together in combination. For example, in the above-described embodiments, the order of each of the operations and the order of each of the processes are illustrated as examples, and the present invention is not necessarily limited to these features. The same applies also in the case that numerical values or mathematical expressions are used in the description of the aforementioned embodiments.

1. A fuel cell system comprising:
a supply pipe through which an oxygen-containing gas flows to a fuel cell;
an exhaust pipe through which the oxygen-containing gas from the fuel cell is discharged;
a bypass pipe connected to the supply pipe and the exhaust pipe and allowing the oxygen-containing gas to bypass the fuel cell;
a connecting section connecting the bypass pipe to the exhaust pipe, wherein
the connecting section includes:
a main body portion having a main flow path extending in a first direction along which the exhaust pipe extends;
a joint portion extending outward in a radial direction of the main flow path from a side portion of the main body portion, the bypass pipe being connected to the joint portion;
a joint flow path formed inside the joint portion and extending in a second direction orthogonal to the main flow path; and
a plurality of flow regulating ribs protruding inward from an inner peripheral surface of the joint portion forming the joint flow path and elongated in the second direction.

2. The fuel cell system according to claim 1, wherein the plurality of flow regulating ribs are arranged at equal intervals in a circumferential direction of the joint flow path.

3. The fuel cell system according to claim 2, wherein the plurality of flow regulating ribs are arranged at positions shifted from the first direction.

4. The fuel cell system according to claim 3, wherein the plurality of flow regulating ribs are arranged at positions ±45° from the first direction.

5. The fuel cell system according to claim 1, wherein the second direction is inclined upward with increasing distance from a first centerline of the main flow path.
